(19) United States
(12) Patent Application Publication
(10) Pub. No.: US 2025/0185012 A1
(43) Pub. Date: Jun. 5, 2025

(54) METHOD AND APPARATUS FOR CODEBOOK-BASED UPLINK MULTI-ANTENNA TRANSMISSION

(71) Applicant: ELECTRONICS AND TELECOMMUNICATIONS RESEARCH INSTITUTE, Daejeon (KR)

(72) Inventors: Woncheol CHO, Daejeon (KR); Young Jo KO, Daejeon (KR); Wooram SHIN, Daejeon (KR); Chanho YOON, Daejeon (KR)

(73) Assignee: ELECTRONICS AND TELECOMMUNICATIONS RESEARCH INSTITUTE, Daejeon (KR)

(21) Appl. No.: 18/956,228

(22) Filed: Nov. 22, 2024

(30) Foreign Application Priority Data
Nov. 30, 2023 (KR) 10-2023-0171893
Nov. 11, 2024 (KR) 10-2024-0159559

(51) Int. Cl. H04W 72/21; H04B 7/0456; H04L 5/00

(52) U.S. Cl. CPC H04W 72/21; H04B 7/0456; H04L 5/0048

(57) ABSTRACT

A method of a terminal performing codebook-based PUSCH transmission may comprise: receiving, from a base station, configuration information of an SRS resource set; receiving downlink reference signals from the base station through a spatial filter corresponding to the SRS resource set, and obtaining downlink channel values based on the received downlink reference signal; determining an SRS precoding matrix based on the downlink channel values, and transmitting, to the base station, an SRS to which the SRS precoding matrix is applied; receiving, from the base station, an SRI and precoding information determined based on the SRS; and determining a PUSCH precoding matrix based on SRS resource(s) indicated by the SRI and the precoding information, and transmitting, to the base station, a PUSCH to which the PUSCH precoding matrix is applied.

### CROSS-REFERENCE TO RELATED APPLICATIONS

This application claims priority to Korean Patent Applications No. 10-2023-0171893, filed on Nov. 30, 2023, and No. 10-2024-0159559, filed on Nov. 11, 2024, with the Korean Intellectual Property Office (KIPO), the entire contents of which are hereby incorporated by reference.

### BACKGROUND

### 1. Technical Field

The present disclosure relates to a wireless communication system, and more particularly, to a method and apparatus for codebook-based uplink multi-antenna transmission.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The multi-antenna transmission technique is also known as a multi-input and multi-output (MIMO) transmission scheme, which may include a transmit diversity technique and a precoding technique. For physical uplink shared channel (PUSCH) precoding, the 3^{rd} generation partnership project (3GPP) New Radio (NR) communication system can support both codebook-based PUSCH transmission and non-codebook-based PUSCH transmission.

When a terminal is connected to a base station equipped with a large-scale or ultra-large-scale MIMO array, an energy-efficient PUSCH precoding scheme or a PUSCH precoding scheme for high frequency efficiency may be required.

### SUMMARY

The present disclosure for resolving the above-described problems is directed to providing a method and apparatus for codebook-based uplink multi-antenna transmission.

A method of a terminal performing codebook-based physical uplink shared channel (PUSCH) transmission, according to an exemplary embodiment of the present disclosure, may comprise: receiving, from a base station, configuration information of a sounding reference signal (SRS) resource set; receiving downlink reference signals from the base station through a spatial filter corresponding to the SRS resource set, and obtaining downlink channel values based on the received downlink reference signal; determining an SRS precoding matrix based on the downlink channel values, and transmitting, to the base station, an SRS to which the SRS precoding matrix is applied; receiving, from the base station, an SRS resource indicator (SRI) and precoding information determined based on the SRS; and determining a PUSCH precoding matrix based on SRS resource(s) indicated by the SRI and the precoding information, and transmitting, to the base station, a PUSCH to which the PUSCH precoding matrix is applied.

The method may further comprise: transmitting, to the base station, information indicating whether the terminal supports the codebook-based PUSCH transmission.

In the receiving of the configuration of the SRS resource set, information related to a number of frequency units to which frequency domain precoding is applied may be received.

The SRS precoding matrix may be generated based on as many spatial domain basis column vectors as a number of transmit antenna ports and as many frequency domain basis column vectors as the number of frequency units, and the spatial domain basis column vectors and the frequency domain basis column vectors may be respectively obtained by decomposing the downlink channel values into spatial and frequency domains.

The SRI may indicate a number of SRS resources equal to or greater than a number of PUSCH transmission layers.

The PUSCH precoding matrix may be generated based on uplink channel coefficient column vectors of a number of selected SRS resource(s) equal to a number indicated by the SRI.

A method of a terminal performing codebook-based PUSCH transmission, according to another exemplary embodiment of the present disclosure, may comprise: receiving, from a base station connected to a plurality of transmission and reception points (TRPs), configuration information of sounding reference signal (SRS) resource sets via a first TRP among the plurality of TRPs; receiving downlink reference signals from the plurality of TRPs through spatial filters corresponding to the SRS resource sets, and obtaining downlink channel values based on the received downlink reference signals; determining SRS precoding matrixes based on the downlink channel values, and transmitting, to the plurality of TRPs, SRSs to which the SRS precoding matrixes are respectively applied; receiving, from the base station and via the first TRP, an SRS resource set indicator indicating SRS resource set(s) determined based on the SRSs, an SRS resource indicator (SRI) for each of the SRS resource set(s), and precoding information for each of the SRS resource set(s); and determining PUSCH precoding matrix(es) based on the SRS resource set(s), SRS resource(s) indicated by the SRI of each of the SRS resource set(s), and the precoding information for each of the SRS resource set(s), and transmitting, to the base station and via the plurality of TRPs, PUSCH(s) to which the determined PUSCH precoding matrix(es) are applied.

The method may further comprise: transmitting, to the base station and via the first TRP, information indicating whether the terminal supports the codebook-based PUSCH transmission.

In the receiving of the configuration of the SRS resource sets, information related to a number of frequency units to which frequency domain precoding is applied may be received.

Each of the SRS precoding matrixes may be generated based on as many spatial domain basis column vectors as a number of transmit antenna ports and as many frequency domain basis column vectors as the number of frequency units, and the spatial domain basis column vectors and the frequency domain basis column vectors may be respectively obtained by decomposing the downlink channel values into spatial and frequency domains.

The SRI indicates a number of SRS resources equal to or greater than a number of PUSCH transmission layers.

Each of the PUSCH precoding matrix(es) may be generated based on uplink channel coefficient column vectors of a number of selected SRS resource(s) equal to a number indicated by the SRI.

When the SRS resource set indicator indicates one SRS resource set, a PUSCH precoding matrix may be determined based on the one SRS resource set, SRS resource(s) indicated by an SRI of the one SRS resource set, and precoding information for the one SRS resource set, and a PUSCH to which the PUSCH precoding matrix is applied may be repeatedly transmitted.

When the SRS resource set indicator indicates a plurality of SRS resource sets, PUSCH precoding matrixes may be determined based on the plurality of SRS resource sets, SRS resource(s) indicated by an SRI of each of the plurality of SRS resource sets, and precoding information for each of the plurality of SRS resource sets, and PUSCHs to which the PUSCH precoding matrixes are respectively applied may be cross-repeatedly transmitted.

When the SRS resource set indicator indicates one SRS resource set, a PUSCH precoding matrix may be determined based on the one SRS resource set, SRS resource(s) indicated by an SRI of the one SRS resource set, and precoding information for the one SRS resource set, and a PUSCH to which the PUSCH precoding matrix is applied may be transmitted through a single panel of the terminal.

When the SRS resource set indicator indicates a plurality of SRS resource sets, PUSCH precoding matrixes are determined based on the plurality of SRS resource sets, SRS resource(s) indicated by an SRI of each of the plurality of SRS resource sets, and precoding information for each of the plurality of SRS resource sets, and PUSCHs to which the PUSCH precoding matrixes are respectively applied may be simultaneously transmitted through multiple panels of the terminal.

A method of a base station supporting codebook-based PUSCH transmission, according to an exemplary embodiment of the present disclosure, may comprise: transmitting, to a terminal, configuration information of a sounding reference signal (SRS) resource set; transmitting downlink reference signals to the terminal; receiving, from the terminal, an SRS precoded according to an SRS precoding matrix, the SRS precoding matrix being determined based on downlink channel values obtained by the terminal receiving the downlink reference signals through a spatial filter corresponding to the SRS resource set; transmitting, to the terminal, an SRS resource indicator (SRI) and precoding information determined based on the received SRS; and receiving, from the terminal, a PUSCH to which a PUSCH precoding matrix determined based on SRS resource(s) indicated by the SRI and the precoding information is applied.

The method may further comprise: receiving, from the terminal, information indicating whether the terminal supports the codebook-based PUSCH transmission.

In the transmitting of the configuration of the SRS resource set, information related to a number of frequency units to which frequency domain precoding is applied may be transmitted to the terminal.

The SRS precoding matrix may be generated based on as many spatial domain basis column vectors as a number of transmit antenna ports and as many frequency domain basis column vectors as the number of frequency units, and the spatial domain basis column vectors and the frequency domain basis column vectors may be respectively obtained by decomposing the downlink channel values into spatial and frequency domains.

Using the method and device for codebook-based uplink multi-antenna transmission according to the present disclosure, the terminal can effectively cope with frequency-selective channels with sparse spatial characteristics based on spatial and frequency domain bases, thereby improving SRS reception strengths at the base station. Additionally, the terminal can apply an uplink precoding technique that achieves high frequency efficiency based on high-resolution CSI.

For example, in a TDD multi-antenna system, the method and device can be used for PUSCH precoding. The terminal can estimate downlink channel values and obtain uplink CSI based on the uplink and downlink channel reciprocity in the TDD system. By performing uplink precoding for the spatial and frequency domains based on the uplink CSI, the terminal can effectively handle frequency-selective channels with sparse spatial characteristics.

For example, in an FDD multi-antenna system, the method and device can be used for PUSCH precoding. The FDD multi-antenna system cannot assume reciprocity between uplink and downlink channels. However, if a frequency gap between the uplink and downlink channels is within a few GHz, it can be assumed that there is angle and delay reciprocity between the two link channels. Therefore, based on the angle and delay reciprocity, the terminal can perform precoding for the spatial and frequency domains on SRS. Consequently, this offers the advantage of supporting higher spatial resolution and coping with frequency-selective channels compared to conventional codebook-based uplink precoding techniques in the NR-supported FDD multi-antenna system.

For example, in a TDD ultra-massive MIMO system, the method and device can be used for PUSCH precoding. Since an ultra-massive MIMO system supports many terminals through numerous downlink antenna ports, it cannot be assumed that all terminals obtain downlink channel values corresponding to all downlink antenna ports within a coherence time and a bandwidth of the channel. Therefore, in the TDD ultra-massive MIMO system, the terminal can utilize downlink channel state information from a time period prior to the coherence time or from frequency bands outside a coherence bandwidth to perform precoding for the spatial and frequency domains on SRS. In this case, if a frequency gap between the downlink and uplink channels is within a few GHz, it can be assumed that there is angle and delay reciprocity in the channel. Furthermore, if channel reciprocity is not preserved in the spatial and frequency domains when utilizing downlink channel state information from a time period prior to the coherence time, the base station can instruct the terminal through an SRI not to use the corresponding spatial and frequency domain basis pairs for uplink precoding. Therefore, the terminal can perform PUSCH precoding that is robust to the time and frequency selectivity of the channel through the above-described method and device.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a sequence chart illustrating a codebook-based PUSCH transmission method according to an exemplary embodiment of the present disclosure in a scenario of using a multi-antenna wireless communication system.

FIG. 4 is a sequence chart illustrating a codebook-based PUSCH transmission method according to an exemplary embodiment of the present disclosure in a multi-TRP environment.

FIG. 5 is a sequence chart illustrating a codebook-based PUSCH transmission method according to another exemplary embodiment of the present disclosure in a multi-TRP environment.

FIG. 6 is a sequence chart illustrating a codebook-based PUSCH transmission method according to yet another exemplary embodiment of the present disclosure in a multi-TRP environment.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

In exemplary embodiments, ‘configuration of an operation (e.g. transmission operation)’ may mean ‘signaling of configuration information (e.g. information element(s), parameter(s)) for the operation’ and/or ‘signaling of information indicating performing of the operation’. ‘Configuration of information element(s) (e.g. parameter(s))’ may mean that the corresponding information element(s) are signaled. The signaling may be at least one of system information (SI) signaling (e.g. transmission of system information block (SIB) and/or master information block (MIB)), RRC signaling (e.g. transmission of RRC message(s), RRC parameter(s) and/or higher layer parameter(s)), MAC control element (CE) signaling (e.g. transmission of a MAC message and/or MAC CE), PHY signaling (e.g. transmission of downlink control information (DCI), uplink control information (UCI), and/or sidelink control information (SCI)), or a combination thereof.

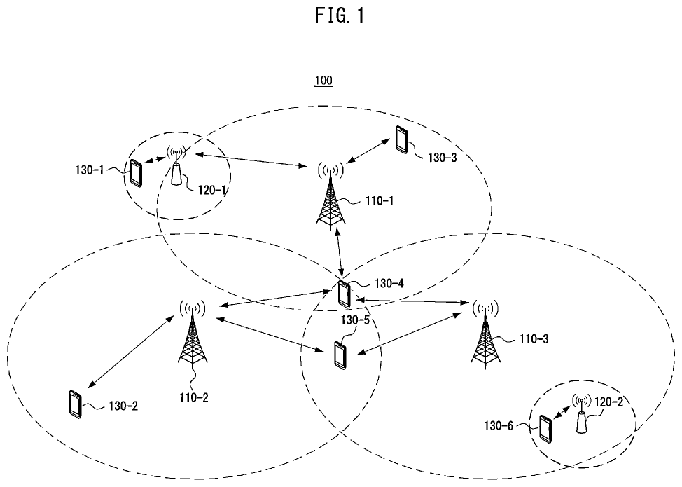

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g. serving-gateway (S-GW), packet data network (PDN)-gateway (P-GW), and mobility management entity (MME)). When the communication system 100 is the 5G communication system (e.g. NR system), the core network may include an access and mobility management function (AMF), a user plane function (UPF), a session management function (SMF), and the like.

The plurality of communication nodes 110 to 130 may support the communication protocols (e.g. LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

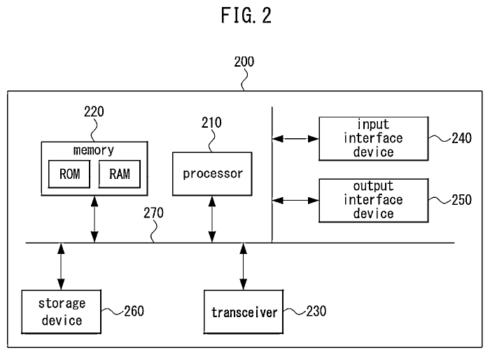

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g. transmission or reception of a data packet) performed at a first communication node among communication nodes is described, the corresponding second communication node may perform a method (e.g. reception or transmission of the data packet) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

The multi-antenna transmission technique is also known as a multi-input and multi-output (MIMO) transmission scheme, which may include a transmit diversity technique and a precoding technique. For physical uplink shared channel (PUSCH) precoding, the 3^{rd} generation partnership project (3GPP) New Radio (NR) communication system can support both codebook-based PUSCH transmission and non-codebook-based PUSCH transmission.

A base station may configure codebook-based PUSCH transmission to a terminal through higher-layer signaling (e.g. radio resource control (RRC) signaling). Through downlink control information (DCI), the base station may indicate, to the terminal, a codebook index, number of transmission layers, and precoding information to be applied during PUSCH transmission. In this case, in order to obtain the number of layers, precoding information, and channel quality indicator (CQI) for PUSCH transmission, the base station may configure a sounding reference signal (SRS) resource set to the terminal through higher-layer signaling. The SRS resource set may include time domain allocation information, frequency domain allocation information, usage purpose, and transmit power control information of SRS resources. When the terminal transmits SRS according to the configured SRS resource set, the base station may receive the SRS and determine the number of layers, precoding information, and CQI for PUSCH transmission. In the case of codebook-based transmission, the precoding information may correspond to an index that indicates a precoding codebook.

The base station may configure multiple SRS resource sets for the terminal. When multiple SRS resource sets are configured, the base station may configure an SRS resource set indicator through DCI. For codebook-based PUSCH transmission, each SRS resource set may be configured with multiple multi-antenna port SRS resources. The base station may configure an SRS resource indicator (SRI) to indicate one of the multiple SRS resources in each SRS resource set to the terminal. The SRI may be indicated to the terminal through DCI along with a precoding codebook index. After receiving the SRI and precoding codebook index through the DCI, the terminal may transmit a PUSCH to which precoding corresponding to the codebook index is applied by using a spatial filter and antenna ports used in the SRS resource indicated by the SRI. This procedure relies only on uplink channel information and does not assume reciprocity between uplink and downlink channels.

Meanwhile, the base station may configure the terminal with non-codebook-based PUSCH transmission through higher-layer signaling. The terminal may receive downlink reference signals transmitted from the base station and select multiple uplink precodings. The terminal may apply each of these uplink precodings to a single-antenna port SRS resource. Based on the received SRS, the base station may indicate, to the terminal, one or multiple SRS resources among multiple SRS resources through an SRI in DCI. Upon receiving the SRI, the terminal may transmit a PUSCH by applying the same spatial filter, antenna port, and precoding applied to the SRS resource indicated by the SRI to the PUSCH.

In the case of non-codebook-based transmission, the terminal does not rely on uplink precoding information defined by a spatial or angular resolution of a precoding codebook, allowing high-resolution uplink precoding to be applied to the PUSCH. However, the terminal needs to select uplink precoding based on the received downlink reference signals, which is generally based on an assumption of reciprocity between uplink and downlink channels.

To address the rapidly increasing wireless data demand, discussions are underway regarding a base station equipped with extreme massive MIMO or ultra-large-scale antenna technologies supporting a higher number of transceivers (TRXs) (e.g. 512 TRXs) than the current massive MIMO technology or large-scale MIMO technology (e.g. 32 TRXs or 64 TRXs). The ultra-large-scale antenna technology may support a corresponding number of antenna ports (e.g. 512 antenna ports) to the number of TRXs. Through enhanced precoding, the ultra-large-scale antenna technology can increase cell capacity or expand coverage.

Additionally, due to the expansion of the wireless communication service area, the mobile communication system may need to support various types of wireless terminals equipped with multiple antennas that have higher requirements. These terminals may be connected to a base station equipped with large-scale or ultra-large-scale MIMO arrays, and may require an energy-efficient PUSCH precoding scheme or a PUSCH precoding scheme for high frequency efficiency.

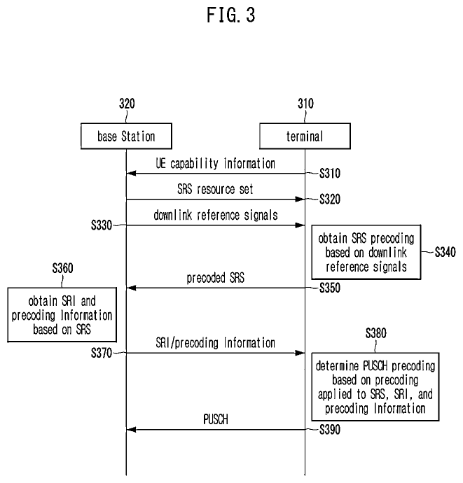

FIG. 3 is a sequence chart illustrating a codebook-based PUSCH transmission method according to an exemplary embodiment of the present disclosure in a scenario of using a multi-antenna wireless communication system.

Referring to FIG. 3, a terminal 310 may report to a base station 320 whether it supports a codebook-based PUSCH transmission method proposed in the present disclosure (S310). For example, the terminal may determine feasibility of performing the codebook-based PUSCH transmission method for spatial and frequency domains based on downlink reference signals received from the base station, and decide whether to support the codebook-based PUSCH transmission method. For instance, the terminal may report its support for the codebook-based PUSCH transmission method to the base station through higher-layer signaling (e.g. UE capability information).

Based on the report in step S310, the base station may determine whether to allow the terminal to perform the codebook-based PUSCH transmission method. For example, the base station may indicate to the terminal whether to apply the codebook-based PUSCH transmission method for spatial and frequency domains, based on the report in step S310. In this case, information related to the number of frequency units to which frequency-domain precoding is applied may be configured. These configurations may be configured as an SRS resource set through higher-layer signaling (S320).

Specifically, the number of frequency units to which frequency-domain precoding is applied may be explicitly configured. In this case, the number of frequency units may be calculated as a combination of the number of SRS frequency resource elements and a frequency unit adjustment parameter within higher-layer parameters. In other words, the frequency unit may be defined by grouping multiple frequency resource elements through the frequency unit adjustment parameter.

Alternatively, the number of frequency units to which frequency-domain precoding is applied may be configured as a combination of SRS frequency domain allocation configuration parameters within the higher-layer parameters. For example, the number of frequency units may be defined as ‘number of SRS frequency resource blocks (RBs) within a single symbol’ within the higher-layer parameters. As another example, the number of frequency units may be defined as a combination of ‘number of SRS frequency RBs within a single symbol’ and ‘sub-frequency sounding parameter for frequency block units’ within the higher-layer parameters. In another example, the number of frequency units may be defined as a combination of ‘frequency hopping information-related parameter’ and ‘number of frequency RBs within a single symbol’ within the higher-layer parameter.

The terminal may receive downlink reference signals corresponding to the SRS resource set configured in step S320 from the base station through a spatial filter, and may obtain downlink channel values based on the received downlink reference signals (S330). For example, the downlink reference signals may include channel state information-reference signal (CSI-RS), synchronization signal block (SSB), and/or downlink demodulation reference signal (DMRS). Based on the obtained downlink channel values, the terminal may obtain a precoding to be applied to SRS resources (S340) and transmit a precoded SRS to the base station (S350). For example, the terminal may obtain the downlink channel values and decompose the downlink channel values into spatial and frequency domains as shown in Equation 1.

$${H}^{DL} = {\sum }_{i = 1}^{{N}_{t}} {\sum }_{j = 1}^{{N}_{f}} {c}_{i j}^{DL} {s}_{i} {f}_{j}^{H} \qquad [ Equation 1 ]$$

In Equation 1, Nₜ denotes the number of SRS transmit antenna ports, N_{f} denotes the number of frequency units, sᵢ denotes a basis column vector for the spatial domain, fⱼ denotes a basis column vector for the frequency domain, and cᵢⱼ^{DL} denotes a channel coefficient corresponding to a pair of the spatial basis sᵢ and the frequency basis fⱼ. For instance, if the number of transmit antenna ports of the terminal is equal to the number of receive antenna ports, the terminal may perform the channel decomposition process of Equation 1 based on the obtained downlink channel values. Alternatively, if the number of transmit antenna ports of the terminal is less than the number of receive antenna ports, the terminal may select SRS transmit antenna port(s) based on the obtained downlink channel values and then perform the channel decomposition process of Equation 1.

The number N_{SRS} of SRS resources may be configured through an SRS resource set. For the number N_{SRS} of SRS resources, the terminal may select a pair of spatial and frequency domain bases to be applied to the n-th SRS resource, where n ∈ {1,2, . . . , N_{SRS}}, and apply precoding in the spatial and frequency domains as shown in Equation 2.

$${x}_{n} ( k ) = {s}_{{i}_{n}} {f}_{{j}_{n}}^{*} ( k ) {p}_{n} ( k ) \qquad [ Equation 2 ]$$

In Equation 2, xₙ(k) indicates the precoded SRS transmitted in the k-th frequency unit of the n-th SRS resource, sᵢ_{ₙ} indicates the spatial domain precoding applied to the n-th SRS resource, f*ⱼₙ (k) indicates the frequency domain precoding applied to the k-th frequency unit of the n-th SRS resource, and pₙ(k) indicate the SRS transmitted in the k-th frequency unit of the n-th SRS resource (i.e. SRS before precoding).

Then, based on the SRS received from the terminal, the base station may obtain uplink channel values and determine an SRI and precoding information (S360). For example, the base station may estimate a channel column vector hₙ^{UL}(k) of size corresponding to the number Nᵣ of base station receive antenna ports for the k-th frequency unit of the n-th SRS resource. The base station may determine an uplink channel coefficient column vector of size Nᵣ corresponding to the n-th SRS resource by summing the channel column vectors across all frequency units, as shown in Equation 3.

$${c}_{n}^{UL} = {\sum }_{k = I}^{{N}_{f}} {h}_{n}^{UL} ( k ) \qquad [ Equation 3 ]$$

The base station may select v channel coefficient column vectors or SRS resources based on the uplink channel coefficient column vector cₙ^{UL} corresponding to each SRS resource. For example, v may be equal to or greater than the number of PUSCH transmission layers. For example, the top v SRS resources may be selected based on energies ∥cₙ^{UL}∥² of the uplink channel coefficient column vectors. For example, a channel coefficient matrix with cₙ^{UL} as the n-th column vector may be generated as shown in Equation 4.

$${C}^{UL} = [ {c}_{1}^{UL} {c}_{2}^{UL} … {c}_{{N}_{SRS}}^{UL} ] \qquad [ Equation 4 ]$$

A submatrix composed of v column vectors may be generated from the uplink channel coefficient matrix in Equation 4, as shown in Equation 5.

$${C}_{v}^{UL} = [ {c}_{{n}_{1}}^{UL} {c}_{{n}_{2}}^{UL} … {c}_{{n}_{v}}^{UL} ] \qquad [ Equation 5 ]$$

For example, SRS resources corresponding to v column vectors that maximize a Frobenius norm ∥(Cᵥ^{UL})^{H}Cᵥ^{UL}∥_{F} of the matrix (Cᵥ^{UL})^{H} Cᵥ^{UL} may be selected. The base station may determine precoding information based on the uplink channel coefficient column vectors corresponding to the selected v SRS resources. For example, the base station may calculate v eigenvectors of the matrix (Cᵥ^{UL})^{H}Cᵥ^{UL}. For example, the base station may select v codebook indexes by calculating an inner product between the column vectors in the codebook and the matrix (Cᵥ^{UL})^{H}Cᵥ^{UL}.

Then, the base station may indicate the SRI and precoding information to the terminal (S370). For example, the SRI may indicate SRS resources corresponding to the number of PUSCH transmission layers. For example, the number of PUSCH transmission layers may be separately indicated, and the SRI may indicate a number of SRS resources greater than the number of layers. For example, the precoding information may include magnitude information, phase information, or both magnitude and phase information. For example, the precoding information may be expressed as codebook index(es) corresponding to magnitude and phase information or phase information of the v eigenvectors ofthe matrix (Cᵥ^{UL})^{H}Cᵥ^{UL}. For example, the precoding information may be expressed as v codebook indexes selected through an inner product of the matrix (Cᵥ^{UL})^{H}Cᵥ^{UL} and column vectors in a predefined codebook. The SRI and precoding information may be indicated through DCI.

Then, the terminal that has received the SRI and precoding information may determine PUSCH precoding based thereon (S380). For example, the terminal may determine uplink precoding spatial and frequency domain basis column vectors corresponding to the SRS resources indicated by the SRI as shown in Equation 6.

$${S}_{v} = [ {s}_{{i}_{{n}_{1}}} {s}_{{i}_{{n}_{2}}} … {s}_{{i}_{{n}_{v}} ]} \qquad [ Equation 6 ]$$

$${F}_{v} = [ {f}_{{j}_{{n}_{1}}} {f}_{{j}_{{n}_{2}}} … {f}_{{j}_{{n}_{v}}} ]$$

Here, n₁, n₂, . . . , nᵥ correspond to indexes of the SRS resources indicated by the SRI. For example, based on the codebook indexes indicated through the precoding information, the terminal may construct an uplink channel coefficient matrix as shown in Equation 7.

$${B}_{v} = [ \begin{matrix}{b}_{11} & … & {b}_{1 v} \\ ⋮ & ⋱ & ⋮ \\ {b}_{v 1} & … & {b}_{vv}\end{matrix} ] \qquad [ Equation 7 ]$$

In this case, each column vector may correspond to each of the v codebook indexes. By combining the spatial and frequency domain PUSCH precoding basis vectors in Equation 6 with the uplink channel coefficient matrix in Equation 7, an uplink precoding matrix may be generated as shown in Equation 8.

$$W = {S}_{v} {B}_{v} {F}_{v}^{H} = {\sum }_{l = 1}^{v} {\sum }_{m = 1}^{v} {s}_{{i}_{{n}_{l}}} {b}_{l m} {f}_{{j}_{{n}_{m}}} \qquad [ Equation 8 ]$$

Finally, the terminal may transmit a PUSCH to the base station using the uplink precoding matrix generated as shown in Equation 8 (S390).

The exemplary embodiment of FIG. 3 described above is an exemplary embodiment of the codebook-based PUSCH transmission method between a terminal and a base station corresponding to a single transmission and reception point (TRP). Hereinafter, exemplary embodiments of a codebook-based PUSCH transmission method between a base station and a terminal in a multi-TRP environment will be described.

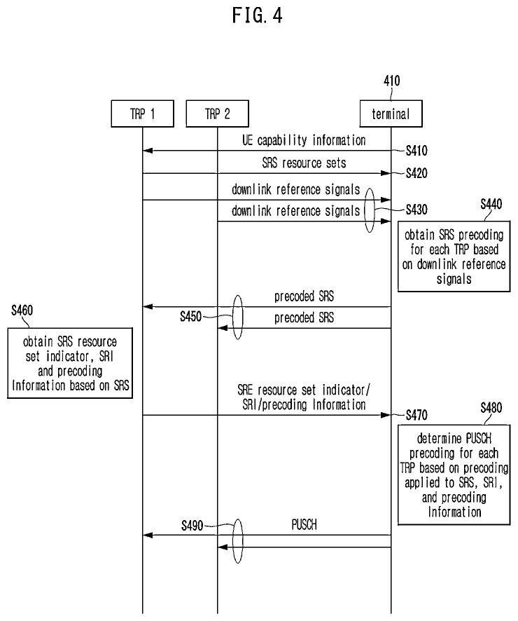

FIG. 4 is a sequence chart illustrating a codebook-based PUSCH transmission method according to an exemplary embodiment of the present disclosure in a multi-TRP environment.

Referring to FIG. 4, a procedure is illustrated in which a terminal cooperates with multiple TRPs (e.g. TRP 1, TRP 2) to repeatedly transmit a single PUSCH with applied precoding, in a scenario using a multi-antenna wireless communication system. In the configuration of FIG. 4, a base station (not shown) may transmit and receive higher-layer signaling and control channels with the terminal via the TRP 1.

A terminal 410, as described in the exemplary embodiment of FIG. 3, may report to the base station via the TRP 1 whether it supports the codebook-based PUSCH transmission method proposed in the present disclosure (S410).

Then, as described in the exemplary embodiment of FIG. 3, based on the report in step S410, the base station may determine whether to allow the terminal to perform the codebook-based PUSCH transmission method and indicate whether to perform the codebook-based PUSCH transmission method to the terminal via the TRP 1 (S420). Additionally, the base station may configure the terminal with the number of repetitions for PUSCH transmission through higher-layer signaling. For each TRP, a higher-layer parameter SRS resource set including these configurations may be configured. The number of frequency units to which frequency-domain precoding is applied may be configured for each SRS resource set in the same manner as described in the exemplary embodiment of FIG. 3.

Then, the terminal may receive downlink reference signals from each TRP through spatial filters corresponding to each SRS resource set and obtain downlink channel values for each TRP based on the received downlink reference signals (S430). Based on the downlink channel values, the terminal may determine precoding to be applied to SRS resources of each SRS resource set (S440). The terminal may then transmit a precoded SRS for each SRS resource set, to which the determined precoding is applied (S450).

Then, the base station may receive the SRSs via each TRP (S460), obtain uplink channel values based on the received SRSs, and determines an SRS resource set indicator, SRI corresponding to an SRS resource set, and precoding information (S460). For example, the SRS resource set indicator may indicate one of the multiple SRS resource sets. Alternatively, the SRS resource set indicator may indicate all of the multiple SRS resource sets. For example, separate uplink power control information may be configured for the multiple SRS resource sets. For example, a second TPC field may be configured through DCI for closed-loop power control.

Then, the base station may indicate the determined SRS resource set indicator, an SRI corresponding to the SRS resource set, and precoding information via the TRP 1 (S470). For example, the SRS resource set indicator, SRI, and precoding information may be indicated through DCI.

Then, if the SRS resource set indicator designates a single SRS resource set, the terminal may determine precoding to be applied to a PUSCH based on the SRI and precoding information as described in the exemplary embodiment of FIG. 3 (S480), and then apply the precoding to the PUSCH for repeated transmission (S490). If the SRS resource set indicator designates multiple SRS resource sets, the terminal may apply precoding to a PUSCH based on the SRI and precoding information for each SRS resource set, as described in the exemplary embodiment of FIG. 3, and perform cross-repeated transmission (S490).

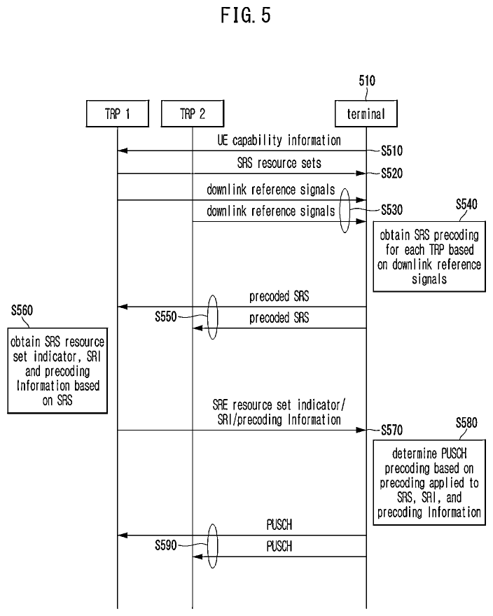

FIG. 5 is a sequence chart illustrating a codebook-based PUSCH transmission method according to another exemplary embodiment of the present disclosure in a multi-TRP environment.

Referring to FIG. 5, a procedure is illustrated in which a terminal equipped with multiple panels cooperates with multiple TRPs (e.g. TRP 1, TRP 2) to simultaneously transmit multiple PUSCHs based on a single DCI in a scenario of a multiple-antenna wireless communication system. In the configuration of FIG. 5, a base station (not shown) may transmit and receive higher-layer signaling and control channels with the terminal via the TRP 1.

The terminal 510, as described in the exemplary embodiment of FIG. 3, may report to the base station via the TRP 1 whether it supports the codebook-based PUSCH transmission method proposed in the present disclosure (S510).

Then, as described in the exemplary embodiment of FIG. 3, based on the report in step S510, the base station may determine whether to allow the terminal to perform the codebook-based PUSCH transmission method and configure whether to perform the codebook-based PUSCH transmission method to the terminal via the TRP 1 (S520). A simultaneous transmission scheme of PUSCHs for the terminal equipped with multiple panels may be configured through higher-layer signaling. For example, the simultaneous transmission scheme for the terminal equipped with multiple panels may be classified into a spatial-domain multiplexing (SDM) scheme and a single-frequency network (SFN)-based transmission scheme. For each TRP, higher-layer parameter SRS resource sets including these configurations may be configured. These configurations may be configured through multiple higher-layer parameter SRS resource sets. The number of frequency units to which frequency-domain precoding is applied may be configured for each SRS resource set in the same manner as described in the exemplary embodiment of FIG. 3.

Then, the terminal may receive downlink reference signals from each TRP through spatial filters corresponding to the SRS resource sets for each TRP and obtain downlink channel values for each TRP based on the received downlink reference signals (S530). Based on the downlink channel values, the terminal may obtain precoding to be applied to SRS resources of each SRS resource set (S540). The terminal may then transmit a precoded SRS for each SRS resource set (S550).

Then, the base station may receive the SRSs via the respective TRPs (S560), obtain uplink channel values based on the received SRSs, and determine an SRS resource set indicator, and an SRI and precoding information corresponding to the SRS resource set (S560). For example, the SRS resource set indicator may designate one of the multiple SRS resource sets. Alternatively, the SRS resource set indicator may designate all of the multiple SRS resource sets.

When the SDM scheme is configured, the base station may determine an uplink channel coefficient column vector c_{i,n}^{UL} for the k-th frequency unit of the n-th SRS resource in the l-th SRS resource set as shown in Equation 3. Based on the uplink channel coefficient column vector c_{i,n}^{UL} corresponding to each SRS resource, the base station may select vₗ SRS resources for the l-th SRS resource set. For example, a sum v=Σₗ vₗ for vₗ SRS resources may be equal to or greater than the number of PUSCH transmission layers. For example, the top vₗ SRS resources may be selected based on energies ∥c_{l,n}^{UL}∥² of the uplink channel coefficient column vectors for the l-th SRS resource set. For example, a channel coefficient matrix with c_{i,n}^{UL} as the ((l−1)·N_{SRS}+n)-th column vector may be generated as shown in Equation 9.

$${C}^{UL} = [ {c}_{1 , 1}^{UL} … {c}_{l , n}^{UL} … {c}_{2 , {N}_{SRS}}^{UL} ] \qquad [ Equation 9 ]$$

Based on the uplink channel coefficient matrix, a submatrix composed of v column vectors may be generated as shown in Equation 5. As described in the exemplary embodiment of FIG. 3, the base station may determine precoding information based on the uplink channel coefficient column vectors corresponding to the selected v SRS resources.

When the SFN-based transmission scheme is configured, the base station may obtain channel values h_{l,n}^{UL} (k) for the k-th frequency unit of the n-th SRS resource in the l-th SRS resource set. The base station may determine an uplink channel coefficient column vector cₙ^{UL} for the n-th SRS resource as shown in Equation 10.

$${c}_{n}^{UL} = {\sum }_{l = 1}^{2} {\sum }_{k = 1}^{{N}_{f}} {h}_{l , n}^{UL} ( k ) \qquad [ Equation 10 ]$$

Based on the uplink channel coefficient column vector cₙ^{UL} corresponding to each SRS resource, the base station may select v SRS resources. For example, v may be equal to or greater than the number of PUSCH transmission layers. For example, the top v SRS resources may be selected based on energies ∥cₙ^{UL}∥² of the uplink channel coefficient column vectors. For example, a channel coefficient matrix with each uplink channel coefficient as a column vector may be generated as shown in Equation 4. Based on this uplink channel coefficient matrix, a submatrix composed of v column vectors may be generated as shown in Equation 5. As described in the exemplary embodiment of FIG. 3, the base station may determine precoding information based on the uplink channel coefficient column vectors corresponding to the selected v SRS resources.

Then, the base station may configure the terminal with the determined SRS resource set indicator, and an SRI and precoding information corresponding to the SRS resource set via the TRP 1 (S570). For example, the SRS resource set indicator, SRI, and precoding information may be indicated through DCI.

If the SRS resource set indicator designates a single SRS resource set, the terminal may apply precoding to a PUSCH corresponding to a single panel based on the SRI and precoding information (S580) and transmit the precoded PUSCH (S590). If the SRS resource set indicator designates multiple SRS resource sets, the terminal may apply precoding to PUSCHs corresponding to the respective panels based on the SRI and precoding information for the respective SRS resource sets (S580) and transmit multiple precoded PUSCHs simultaneously (S590).

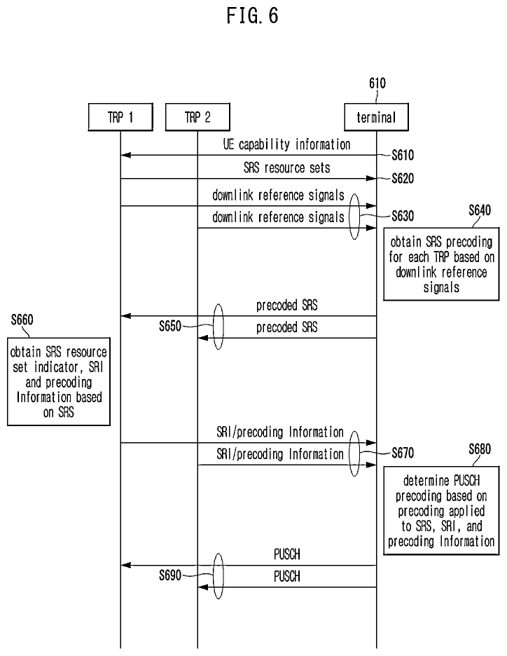

FIG. 6 is a sequence chart illustrating a codebook-based PUSCH transmission method according to yet another exemplary embodiment of the present disclosure in a multi-TRP environment.

Referring to FIG. 6, a procedure is illustrated in which a terminal equipped with multiple panels cooperates with multiple TRPs (e.g. TRP 1, TRP 2) to simultaneously transmit multiple PUSCHs based on DCIs (multiple DCIs) corresponding to the respective TRPs in a scenario of a multi-antenna wireless communication system. In the configuration of FIG. 6, a base station (not shown) may transmit and receive higher-layer signaling and control channels with the terminal via the TRP 1.

In the exemplary embodiment of FIG. 6, steps S610 to S650 may be performed in the same manner as steps S510 to S550 in the exemplary embodiment of FIG. 5.

However, in the case of the multi-DCI-based procedure according to the exemplary embodiment of FIG. 6, each SRS resource set and precoding information may be determined to correspond to each CORESETPool (S660). Therefore, each TRP may configure the terminal with an SRI and precoding information through each DCI (S670). The terminal may apply precoding to a PUSCH corresponding to each panel based on the SRI and precoding information for each SRS resource set (S680) and may transmit multiple PUSCHs simultaneously (S690).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal performing codebook-based physical uplink shared channel (PUSCH) transmission, comprising:
receiving, from a base station, configuration information of a sounding reference signal (SRS) resource set;
receiving downlink reference signals from the base station through a spatial filter corresponding to the SRS resource set, and obtaining downlink channel values based on the received downlink reference signal;
determining an SRS precoding matrix based on the downlink channel values, and transmitting, to the base station, an SRS to which the SRS precoding matrix is applied;
receiving, from the base station, an SRS resource indicator (SRI) and precoding information determined based on the SRS; and
determining a PUSCH precoding matrix based on SRS resource(s) indicated by the SRI and the precoding information, and transmitting, to the base station, a PUSCH to which the PUSCH precoding matrix is applied.

2. The method according to claim 1, further comprising: transmitting, to the base station, information indicating whether the terminal supports the codebook-based PUSCH transmission.

3. The method according to claim 1, wherein in the receiving of the configuration of the SRS resource set, information related to a number of frequency units to which frequency domain precoding is applied is received.

4. The method according to claim 3, wherein the SRS precoding matrix is generated based on as many spatial domain basis column vectors as a number of transmit antenna ports and as many frequency domain basis column vectors as the number of frequency units, and the spatial domain basis column vectors and the frequency domain basis column vectors are respectively obtained by decomposing the downlink channel values into spatial and frequency domains.

5. The method according to claim 1, wherein the SRI indicates a number of SRS resources equal to or greater than a number of PUSCH transmission layers.

6. The method according to claim 5, wherein the PUSCH precoding matrix is generated based on uplink channel coefficient column vectors of a number of selected SRS resource(s) equal to a number indicated by the SRI.

7. A method of a terminal performing codebook-based physical uplink shared channel (PUSCH) transmission, comprising:
receiving, from a base station connected to a plurality of transmission and reception points (TRPs), configuration information of sounding reference signal (SRS) resource sets via a first TRP among the plurality of TRPs;
receiving downlink reference signals from the plurality of TRPs through spatial filters corresponding to the SRS resource sets, and obtaining downlink channel values based on the received downlink reference signals;
determining SRS precoding matrixes based on the downlink channel values, and transmitting, to the plurality of TRPs, SRSs to which the SRS precoding matrixes are respectively applied;
receiving, from the base station and via the first TRP, an SRS resource set indicator indicating SRS resource set(s) determined based on the SRSs, an SRS resource indicator (SRI) for each of the SRS resource set(s), and precoding information for each of the SRS resource set(s); and
determining PUSCH precoding matrix(es) based on the SRS resource set(s), SRS resource(s) indicated by the SRI of each of the SRS resource set(s), and the precoding information for each of the SRS resource set(s), and transmitting, to the base station and via the plurality of TRPs, PUSCH(s) to which the determined PUSCH precoding matrix(es) are applied.

8. The method according to claim 7, further comprising: transmitting, to the base station and via the first TRP, information indicating whether the terminal supports the codebook-based PUSCH transmission.

9. The method according to claim 7, wherein in the receiving of the configuration of the SRS resource sets, information related to a number of frequency units to which frequency domain precoding is applied is received.

10. The method according to claim 9, wherein each of the SRS precoding matrixes is generated based on as many spatial domain basis column vectors as a number of transmit antenna ports and as many frequency domain basis column vectors as the number of frequency units, and the spatial domain basis column vectors and the frequency domain basis column vectors are respectively obtained by decomposing the downlink channel values into spatial and frequency domains.

11. The method according to claim 7, wherein the SRI indicates a number of SRS resources equal to or greater than a number of PUSCH transmission layers.

12. The method according to claim 11, wherein each of the PUSCH precoding matrix(es) is generated based on uplink channel coefficient column vectors of a number of selected SRS resource(s) equal to a number indicated by the SRI.

13. The method according to claim 7, wherein when the SRS resource set indicator indicates one SRS resource set, a PUSCH precoding matrix is determined based on the one SRS resource set, SRS resource(s) indicated by an SRI of the one SRS resource set, and precoding information for the one SRS resource set, and a PUSCH to which the PUSCH precoding matrix is applied is repeatedly transmitted.

14. The method according to claim 7, wherein when the SRS resource set indicator indicates a plurality of SRS resource sets, PUSCH precoding matrixes are determined based on the plurality of SRS resource sets, SRS resource(s) indicated by an SRI of each of the plurality of SRS resource sets, and precoding information for each of the plurality of SRS resource sets, and PUSCHs to which the PUSCH precoding matrixes are respectively applied are cross-repeatedly transmitted.

15. The method according to claim 7, wherein when the SRS resource set indicator indicates one SRS resource set, a PUSCH precoding matrix is determined based on the one SRS resource set, SRS resource(s) indicated by an SRI of the one SRS resource set, and precoding information for the one SRS resource set, and a PUSCH to which the PUSCH precoding matrix is applied is transmitted through a single panel of the terminal.

16. The method according to claim 7, wherein when the SRS resource set indicator indicates a plurality of SRS resource sets, PUSCH precoding matrixes are determined based on the plurality of SRS resource sets, SRS resource(s) indicated by an SRI of each of the plurality of SRS resource sets, and precoding information for each of the plurality of SRS resource sets, and PUSCHs to which the PUSCH precoding matrixes are respectively applied are simultaneously transmitted through multiple panels of the terminal.

17. A method of a base station supporting codebook-based physical uplink shared channel (PUSCH) transmission, comprising:
transmitting, to a terminal, configuration information of a sounding reference signal (SRS) resource set;
transmitting downlink reference signals to the terminal;
receiving, from the terminal, an SRS precoded according to an SRS precoding matrix, the SRS precoding matrix being determined based on downlink channel values obtained by the terminal receiving the downlink reference signals through a spatial filter corresponding to the SRS resource set;
transmitting, to the terminal, an SRS resource indicator (SRI) and precoding information determined based on the received SRS; and
receiving, from the terminal, a PUSCH to which a PUSCH precoding matrix determined based on SRS resource(s) indicated by the SRI and the precoding information is applied.

18. The method according to claim 17, further comprising: receiving, from the terminal, information indicating whether the terminal supports the codebook-based PUSCH transmission.

19. The method according to claim 17, wherein in the transmitting of the configuration of the SRS resource set, information related to a number of frequency units to which frequency domain precoding is applied is transmitted to the terminal.

20. The method according to claim 19, wherein the SRS precoding matrix is generated based on as many spatial domain basis column vectors as a number of transmit antenna ports and as many frequency domain basis column vectors as the number of frequency units, and the spatial domain basis column vectors and the frequency domain basis column vectors are respectively obtained by decomposing the downlink channel values into spatial and frequency domains.
